(19) United States
(12) Patent Application Publication
(10) Pub. No.: US 2018/0346611 A1
(43) Pub. Date: Dec. 6, 2018

(54) COATING AND METHOD FOR FORMING THE SAME

(71) Applicant: YU-TAO WU, Hsinchu County (TW)

(72) Inventor: YU-TAO WU, Hsinchu County (TW)

(21) Appl. No.: 15/637,609

(22) Filed: Jun. 29, 2017

(30) Foreign Application Priority Data
Jun. 1, 2017 (CN) 201710404022.8

(51) Int. Cl. C08F 2/24; C08F 257/02; C09D 151/08; C09D 143/04; C08F 2/10; C09D 7/12; D21H 19/52; C08K 3/36

(52) U.S. Cl. CPC C08F 2/24; C08F 257/02; C09D 151/085; C09D 143/04; C08L 2201/54; C09D 7/125; D21H 19/52; C08K 3/36; C08F 2/10

(57) ABSTRACT

A coating including a composition of 5% to 10% by weight of water, 5% to 20% by weight of silica sol, 0.05% to 0.2% by weight of KH-560 silane coupling agent, and 20% to 60% by weight of quartz powder is disclosed. The forming method for the coating includes mixing the water, the silica sol, and the KH560-silane coupling agent into a decomposing agent; adding a wetting agent, phthalein white powder, modified bentonite, quartz powder, and a styrene-acrylate emulsion or a pure acrylate emulsion into the decomposing agent to form a mixing agent; adding a carboxymethyl cellulose, a crosslinking agent, a fungicide and a deodorant into the mixing agent to form a thickened mixing agent; and adding a deforming agent into the thickened mixing agent to form the coating. The quartz coating has advantages of effectively improve living environment and good covering ability.

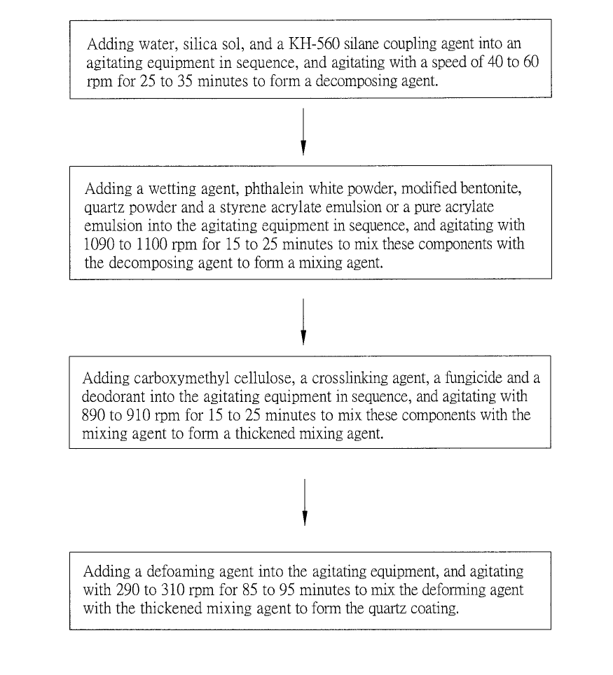

### BACKGROUND OF THE INVENTION

### 1. Technical Field

The present invention is related to a coating and its forming method, and more particularly to an environmental water-borne quartz coating and a method for forming the same.

### 2. Description of Related Art

Most traditional interior/exterior wall latex coatings contain harmful substances, such as formaldehyde. Though formaldehyde can be used as a preservative and has advantages of increasing adhesion ability and inhibiting insect eggs, now formaldehyde is determined by World Health Organization as a carcinogenic and baby-deforming substance. In addition, releasing of formaldehyde from architecture coatings can be lasted for 3 to 15 years, and is greatly harmful to human health, mainly in olfactory abnormalities, allergies, abnormal lung function, abnormal liver function, and abnormal immune function.

Therefore, in recent years, formaldehyde-free coatings, even deformaldehyde coatings, have gradually replaced conventional latex coatings. However, how to form a coating capable of improving the living environment, and also having good covering ability is still a research topic and a development trend for coating manufacturers.

### BRIEF SUMMARY OF THE INVENTION

From the above, the present invention is to provide an environmental water-borne coating and a method for forming the same. The coating is not only without harmful substances, but also has good covering ability.

To achieve the above purpose, the present invention provides a coating including a composition of 5% to 10% by weight of water, 5% to 20% by weight of silica sol, 0.05% to 0.2% by weight of KH-560 silane coupling agent, and 20% to 60% by weight of quartz powder.

The present invention also provides a method for forming the coating, includes steps of:
A. adding water, silica sol, and a KH-560 silane coupling agent into an agitating equipment, and mixing these components into a decomposing agent;
B. adding a wetting agent, phthalein white powder, modified bentonite, quartz powder into the agitating equipment, then adding a styrene-acrylate emulsion or a pure acrylate emulsion into the agitating equipment, and then mixing these components with the decomposing agent to form a mixing agent;
C. adding carboxymethyl cellulose, a crosslinking agent, a fungicide and a deodorant into the agitating equipment, and mixing these components with the mixing agent to perform viscosity adjustment and to form a thickened mixing agent; and
D. adding a defoaming agent into the agitating equipment, and mixing it with the thickened mixing agent to remove foams from the thickened mixing agent so as to form the coating.

The advantage of the present invention is that the coating with the above composition and forming method not only can effectively improve our living environment, but also has good covering ability. Besides, the coating can be used in high and low-temperature environment, and is without cracking. The forming process thereof is simple and is easy for commercial production.

### BRIEF DESCRIPTION OF THE SEVERAL VIEWS OF THE DRAWINGS

The present invention will be best understood by referring to the following detailed description of some illustrative embodiments in conjunction with the accompanying drawing, in which

The sole FIGURE is a flowchart of a forming method for a quartz coating according to an embodiment of the present invention.

### DETAILED DESCRIPTION OF THE INVENTION

The following illustrative embodiments and drawings are provided to illustrate the disclosure of the present invention, these and other advantages and effects can be clearly understood by persons skilled in the art after reading the disclosure of this specification. First, the composition and weight percentages of a coating according to an embodiment of the invention are shown in Table 1.

TABLE 1
Composition and weight percentages of the coating

| Composition | Weight Percentage (%) |
|---|---|
| Water | 5%-20% |
| Silica sol | 5%-20% |
| KH-560 Silane coupling agent | 0.05%-0.2% |
| Wetting agent | 1%-3% |
| Phthalein white powder | 1%-5% |
| Modified bentonite | 0.1%-5% |
| Quartz powder | 20%-60% |
| Styrene-acrylate emulsion (Pure acrylate | 10%-30% |
| emulsion) | |
| Carboxymethyl cellulose | 0.01%-0.5% |
| Crosslinking reagent | 0.1%-1% |
| Fungicide | 0.1%-0.5% |
| Deodorant | 0.1%-0.6% |
| Defoaming agent | 0.1%-0.5% |

Besides, each component of the coating with the above weight percentage can achieve:

Water
Water is utilized as a solvent for water borne coating. When a weight percentage of water in the coating is 5% to 20%, the coating will have a most suitable viscosity and is convenient for application and production.

Silica Sol
Silica sol includes a quantitative film-forming/dissolving property. Its water resistance and heat resistance is better than organic coatings. When a weight percentage of silica sol is 5% to 20%, its effectiveness to the coating is obvious. Even if the weight percentage of silica sol is too high, it will not cause cracking or foams in the coatings.

KH-560 Silane Coupling Agent
KH-560 Silane coupling agent includes one organic functional group R′ at its one terminal, and the organic functional group R′ has good affinity to polymers. Therefore, it can tightly adhere to the surface of quartz powder particles or silicon dioxide particles and form a reactive coating film. When a weight percentage of the KH560-Silane coupling agent is 0.05% to 0.2%, its effectiveness to the coating is obvious. Even if the weight percentage of the KH560-Silane is too high, it will not cause cracking or foams in the coating.

Wetting Agent
Wetting agent is used to reduce surface tension of the coating and increase the wettability of the substrate so as to improve adherence and color development of the coating. When a weight percentage of the wetting agent is 1% to 3%, its effectiveness to the coating is obvious. Even if the weight percentage thereof is too high, surface defects such as fish eye will not occur on the coating surface.

Phthalein White Powder
Phthalein white powder is used to increase the coating's covering ability. When a weight percentage of the phthalein white powder is 1% to 5%, its effectiveness to the coating is obvious. Even if the weight percentage thereof is too high, it will not make the coating become pasty in the forming process, and will not increase the coating's manufacturing cost.

Modified Bentonite
Modified bentonite can effectively solve the problem of quartz precipitation. When a weight percentage of modified bentonite is 0.1% to 5%, its effectiveness to the coating is obvious. Even if the weight percentage thereof is too high, it will not form a pasty coating in the coating's forming process.

Quartz Powder
Quartz powder is a powder filler, which can increase the coating's resistance to abrasion, acid, alkali and erosion. When a weight percentage of quartz powder is 20% to 60%, its effectiveness to the coating is obvious. Even if the weight percentage thereof is too high, it not will harden the coating or generate lumps in the coating, and also can avoid film cracking when the coating applies on the wall.

Styrene-Acrylate Emulsion
Styrene-acrylate emulsion includes an excellent adhesion ability, and can form a transparent film. It also includes good water resistance, oil resistance, heat resistance and aging resistance. When a weight percentage of the styrene-acrylate emulsion is 10% to 30%, its effectiveness to the coating is obvious. Even if its weight percentage is too high, it will not increase the manufacturing cost.

Pure Acrylate Emulsion
Pure acrylate emulsion includes an excellent aging resistance, and also includes good water resistance, oil resistance and heat resistance. When a weight percentage of the pure acrylate emulsion is 10% to 30%, its effectiveness to the coating is obvious. Even if the weight percentage thereof is too high, it will not increase the manufacturing cost.

Carboxymethyl Cellulose
Carboxymethyl cellulose is used for thickening, film-forming, adhering, moisture retention, gel protection, emulsion, and suspension, etc. When a weight percentage of the carboxymethyl cellulose is 0.01% to 0.5%, its effectiveness to the coating is obvious. Even if the weight percentage thereof is too high, it will not increase the coating's viscosity and make the working process difficult.

Crosslinking Agent
Crosslinking agent provides a high shear viscosity for the coating. It also includes good fluidity and leveling. Its rheological property is similar to Newtonian fluid, and is especially suitable for water-borne coatings which are critical with leveling and viscosity. When a weight percentage of the crosslinking agent is 0.1% to 1%, its effectiveness to the coating is obvious. Even if the weight percentage thereof is too high, it will not increase the coating's viscosity and make the working process difficult.

Fungicide
Fungicide is used for destroying or inhibiting mold, and can prevent milden and rot. When a weight percentage of fungicide is 0.1% to 0.5%, its effectiveness to the coating is obvious. Even if the weight percentage thereof is too high, it will not make the coating generate sharp smell.

Deodorant
Deodorant is used to prevent water become smelly due to long time storage. When a weight percentage of deodorant is 0.1% to 0.6%, its effectiveness to the coating is obvious. Even if the weight percentage thereof is too high, it will not make the coating generate sharp smell.

Defoaming Agent
Defoaming agent includes properties of small surface tension, high surface activity, and strong defoaming ability. Especially, under room-temperature conditions, the defoaming agent has a fast defoaming speed and can achieve a better defoaming result. When a weight percentage of the defoaming agent is 0.1% to 0.5%, its effectiveness to the coating is obvious. Even if the weight percentage of the defoaming agent is too high, it will not produce blisters on the coating surface.

The composition and weight percentages of a quartz coating of an embodiment according to the present invention is shown in Table 2. In this embodiment, water includes reverse osmosis water, distilled water, or tap water without impurities. Besides, the weight ratio of silica sol to the KH-560 silane coupling agent is 100:1.

TABLE 2
The composition and weight percentages of a quartz coating

| Composition | Weight percentage (%) |
|---|---|
| Water | 16.7% |
| Silica sol | 5% |
| KH-569 silane coupling agent | 0.05% |
| Wetting agent | 2.27% |
| Phthalein white powder | 2.27% |
| Modified bentonite | 0.15% |
| Quartz powder (grain size: 400 to 2500 mesh) | 57.32% |
| Styrene-acrylate emulsion (Pure acrylate | 14.55% |
| emulsion) | |
| Carboxymethyl Cellulose | 0.03% |
| Crosslinking agent | 0.98% |
| Fungicide | 0.3% |
| Deodorant | 0.56% |
| Defoaming agent | 0.14% |

Each weight percentage of the silica sol and the KH-560 silane coupling agent in the coating composition, and the relative ratio thereof are critical to the characteristic of the coating. Wherein, when the relative ratio of silica sol to the KH-560 silane coupling agent is 100:1, the quartz powder can be uniformly dispersed in the coating. If the quartz powder is not uniformly dispersed in the coating, it will cause the coating film on a wall become cracked. The quartz powder of this embodiment includes grain sizes of 400 to 2500 mesh. However, in other embodiments, the grain size of the quartz powder is not limited thereto. Besides, in this embodiment, the viscosity tested with a Stormer viscosmeter is 70 to 80 KU.

Besides, a forming method for the coating of this embodiment is shown in the sole FIGURE, including steps of A to D:

Step A: Adding water, silica sol, and the KH-560 silane coupling agent into an agitating equipment according to the weight percentages shown in Table 2, and agitating with a speed of 40 to 60 rpm for 25 to 35 minutes to form a decomposing agent.

In the above forming process of the quartz coating of this embodiment, preferably, the agitation speed of this step is 50 rpm, and the agitation time is 30 minutes. Besides, the adding sequence of silica sol and KH-560 silane coupling agent is not limited. That is, adding the KH-560 silane coupling agent first and then adding the silica sol will not affect the formation of the coating.

Step B: Adding the wetting agent, the phthalein white powder, the modified bentonite, the quartz powder and the styrene-acrylate emulsion into the agitating equipment according to the relative weight percentages shown in Table 2, and agitating with 1090 to 1100 rpm for 15 to 25 minutes to mix the above components with the decomposing agent to form a mixing agent. Wherein, the styrene-acrylate emulsion can be replaced with a pure acrylate emulsion.

In this embodiment, the agitation speed of the above step in the quartz coating forming process is preferably 1100 rpm, and the agitation time thereof is preferably 20 minutes. Besides, since the weight percentages of wetting agent, phthalein white powder and modified bentonite are small, the adding sequence thereof is not limited. In other words, in other embodiments, the components can be added into the agitating equipment with a replaceable sequence. For example, the wetting agent, the phthalein white powder and the modified bentonite can be added first, and then the quartz powder and the styrene-acrylate emulsion (or pure acrylate emulsion) are added so as to utilize each component's function effectively.

Step C: Adding the carboxymethyl cellulose, the crosslinking agent, the fungicide and the deodorant into the agitating equipment according to the weight percentages shown in Table 2, and agitating with 890 to 910 rpm for 15 to 25 minutes to mix the above components with the mixing agent to form a thickened mixing agent.

In this embodiment, the agitation speed of this step in the forming process of the quartz coating is preferably 900 rpm, and the agitation time is preferably 20 minutes. Besides, in other embodiments, the adding sequence of the components is not limited.

Step D: Adding the defoaming agent into the agitating equipment according to the weight percentage shown in Table 2, and agitating with 290 to 310 rpm for 85 to 95 minutes to mix the deforming agent with the thickened mixing agent to remove foams from the thickened mixing agent so as to form the quartz coating.

In this embodiment, the agitation speed in this step of the forming process of the quartz coating is preferably 300 rpm, and the agitation time thereof is preferably 90 minutes.

Besides, in Step D, a Stormer viscometer is utilized to measure the viscosity of the quartz coating. The final viscosity thereof is 70 to 80 KU. By the way, in practice, the agitating equipment utilized in the above forming method includes an agitator, a stirring barrel, or a Banbury mixer.

In summary, the environmental water-borne coating of the present invention utilizes a water-based forming method. Its manufacturing process is simple and easy for commercial production. Besides, the quartz coating is characterized in that, it is an environmental water-borne coating, and not only has good covering ability, but also will not cause film cracking under high and low-temperature environment; besides, it is toxic free and will not leave sharp smells after 3 working days so as to maintain good living quality.

It must be pointed out that the embodiments described above are only some embodiments of the present invention. All equivalent structures which employ the concepts disclosed in this specification and the appended claims should fall within the scope of the present invention.

What is claimed is:

1. A coating, comprising a composition of:
5% to 20% by weight of water, 5% to 20% by weight of silica sol, 0.05% to 0.2% by weight of KH-560 silane coupling agent, and 20% to 60% by weight of quartz powder.

2. The coating of claim 1, wherein the weight ratio of the silica sol to the KH-560 silane coupling agent is 100:1.

3. The coating of claim 2, wherein a weight percentage of the silica sol is 5%, and a weight percentage of the KH-560 silane coupling agent is 0.05%.

4. The coating of claim 1, further comprising the following components:
1% to 3% by weight of a wetting agent, 1% to 5% by weight of phthalein white powder, 0.1% to 5% by weight of modified bentonite, 10% to 30% by weight of a styrene-acrylate emulsion or a pure acrylate emulsion, 0.1% to 5% by weight of a carboxymethyl cellulose, 0.1% to 1% by weight of a crosslinking agent, 0.1% to 0.5% by weight of a fungicide, 0.1% to 0.6% by weight of a deodorant, and 0.1% to 0.5% by weight of a defoaming agent.

5. The coating of claim 1, wherein a viscosity of the coating is 70 to 80 U.

6. A method for forming a coating, comprising steps of:
A. adding water, silica sol, and a KH-560 silane coupling agent into an agitating equipment, and mixing these components to form a decomposing agent;
B. adding a wetting agent, phthalein white powder, modified bentonite, quartz powder into the agitating equipment, then adding a styrene acrylate emulsion or an acrylate emulsion into the agitating equipment, and mixing these components with the decomposing agent to form a mixing agent;
C. adding carboxymethyl cellulose, a crosslinking agent, a fungicide and a deodorant into the agitating equipment, and mixing these components with the mixing agent to adjust viscosity and form a thickened mixing agent; and
D. adding a defoaming agent into the agitating equipment, and mixing it with the thickened mixing agent to remove foams from the thickened mixing agent to form the coating.

7. The method of claim 6, wherein in step B, the wetting agent, the phthalein white powder and the modified bentonite are added into the agitating equipment first, and then the quartz powder is added into the agitating equipment.

8. The method of claim 6, wherein an agitation speed of step A is 40 to 60 rpm, and an agitation time of step A is 25 to 35 minutes.

9. The method of claim 6, wherein an agitation speed of step B is 1090 to 1110 rpm, and an agitation time of step B is 15 to 25 minutes.

10. The method of claim 6, wherein an agitation speed of step C is 890 to 910 rpm, and an agitation time of step C is 15 to 25 minutes.

11. The method of claim 6, wherein an agitation speed of step D is 290 rpm and 310 rpm, and an agitation time of step D is 85 to 95 minutes.
